(19) United States
(12) Patent Application Publication
(10) Pub. No.: US 2010/0031095 A1
(43) Pub. Date: Feb. 4, 2010

(54) METHOD AND APPARATUS FOR ENHANCING TICKETING SYSTEM IN A SERVICE MANAGEMENT PROCESS FOR EFFICIENT PROBLEM RESOLULTION

(76) Inventors: Yaoping Ruan, White Plains, NY (US); Debanjan Saha, Westchester County, NY (US); Ramendra K. Sahoo, Westchester County, NY (US); Sambit Sahu, Hopewell Junction, NY (US); Anees Shaikh, Yorktown Heights, NY (US)

Correspondence Address: Connoily Bove Lodge & Hutz LLP, Suite 1100, 1875 Eye Street, NW, Washington, DC, 20006, US

(21) Appl. No.: 12/181,563

(22) Filed: Jul. 29, 2008

(51) Int. Cl. G06F 11/07

(52) U.S. Cl. 714/57; 714/E11.025

(57) ABSTRACT

Problem ticket usage is improved by adding dynamic information to the ticket or using dynamic information to prompt the user or customer for additional information. Two categories of dynamic information are used. In the case where an initial problem ticket involves identification of a problem component the dynamic information is derived from abnormal status of related components, such as components which support the problem component. In the case where an initial problem ticket involves problem symptom information, data is derived from resolved problem tickets by identifying important words or concepts which are stored in connection with the particular symptom. When later problem tickets having the same symptom are identified the related important words or concepts are either added to the problem ticket or are used to prompt customers or users for additional information. A system implementing an embodiment of the invention is also described.

### BACKGROUND

Problem ticket generation usually is the first step in today's IT process services management. This step is responsible for describing problem symptoms reported by customers. The problem ticket is the link between customer and the services infrastructure. Once a problem ticket is generated, it will be queued in the ticketing system and routed to an appropriate center or person for resolution. In practice, such a ticket can be generated either manually by call center personnel, or automatically via monitoring systems. In both cases, there are several fields to be documented in the ticket body from the party reporting the problem.

Quite often it has been the case that either the information found in the problem ticket is not adequate for resolution personnel or sometime the information is inaccurate. This is because: (I) fields in each ticket category are predetermined and hence fail to exploit any situational issues, (II) experience from previous tickets are not used in the preparation of similar future tickets, (III) there is no mechanism for the front-desk personnel to collect additional information beyond those available from the reporting party.

### SUMMARY OF THE INVENTION

This invention provides a method and apparatus for enhancing ticket generation process by collecting more relevant information at the creation of a ticket for reporting a problem. Instead of using a fixed set of questions (which is typical), information for the ticket is dynamically generated. The dynamic information can appear in the form of questions which may account for (I) situational information (i.e., currently seen problems, current state of the user system etc), (II) knowledge gathered from previous tickets (i.e., what information are more useful for this type of symptoms etc.), and (III) information gathered proactively based on his/her experience by the agent. However the invention is not limited to these above mentioned factors. The core of the invention is that by making use of situational information both from current situation, and past scenarios, one can collect more useful information as opposed to using only predetermined questions or content.

In connection with one aspect the invention provides a method of preparing a problem ticket comprising:

receiving a problem report,

accessing a data collection based on said problem report to retrieve dynamic information related to said problem, and

forwarding said problem report and said dynamic information to comprise a problem ticket for resolution.

In connection with another aspect the invention provides a method of preparing a problem ticket comprising:

receiving a problem report, and at least one problem symptom;

accessing a data collection based on said problem symptom to retrieve dynamic information related to said at least one problem symptom, and

forwarding as a problem ticket said report and said dynamic information for resolution.

The invention also comprehends a system useful in enhancing a problem ticket comprising

a data collection comprising status of user system components and relationship between target system components
means responsive to data comprising a problem report for identifying components which are either identified in said problem report or are related components
means for extracting information respecting current status of said related components, and
means for forwarding said information respecting current status for inclusion in said problem ticket.

### BRIEF DESCRIPTION OF THE DRAWINGS

To describe the foregoing and other exemplary purposes, aspects, and advantages, we use the following detailed description of exemplary embodiments of the invention with reference to the drawings in which:

FIG. 1 shows a typical problem ticket;

FIG. 2 shows conventional problem ticket flow from customer request to end of service;

FIG. 3 shows conventional end to end life cycle of a problem ticket;

FIG. 4 shows improved information flow for ticket generation where dynamic information may be used; and

FIG. 5 presents a specific embodiment.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

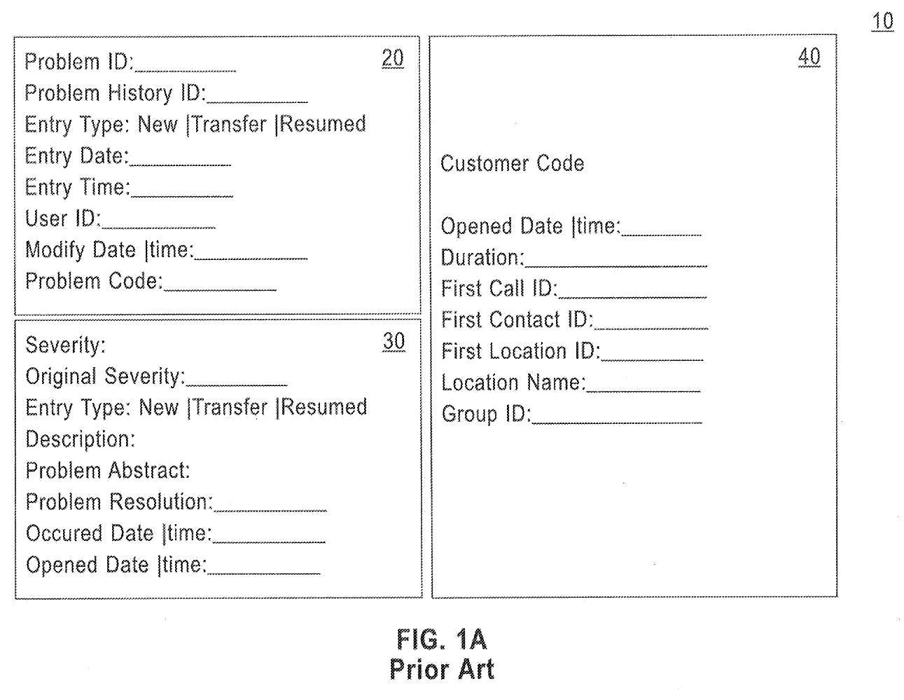

FIG. 1 is a schematic illustration of a typical problem ticket 10. The problem ticket 10 includes a problem ID section 20, a severity section 30, and a customer region 40.

The problem ID section 20 has regions wherein information can be provided for identification of the problem, identification of the problem history, problem type, whether new, transferred or resumed, entry date and time, user ID, the date and time in which the problem ticket was modified and a problem code.

The severity region 30 has a place where information can be provided for the original severity of the problem and a description section in which there is provision for a problem abstract, a problem resolution, the problem occurrence (date and time), and when the problem ticket was opened (date and time).

Finally, the customer code region 40 has information about the customer such as, when opened (date and time) the duration, the first call identification, the first contact identification, the first location identification, the location named and a group identification.

In some cases, the information for the problem ticket can be provided by a clerk conversing with the user or customer and receiving a problem report about a specific system which provides services to a user or users (herein after ‘user system’). Alternatively, an automated clerk can input the required information from the customer's verbalization of the problem report and a speech-to-text converter.

Regardless of how the information for the problem ticket is recorded, a major difficulty that we have discovered is that, while information input into a problem ticket will vary from ticket to ticket, the type of information which is input is the same for all tickets. In particular, the problem ticket records the observations and experience of the person making the report. It follows that the type of information which is now used to complete a problem ticket is limited to that provided by the customer or user concerning the user system.

As will be described, we believe that different problems requite different categories of information for an adequate description. Thus, in accordance with our invention the types of information that are recorded on one problem ticket will differ from the types of information that are recorded on another problem ticket.

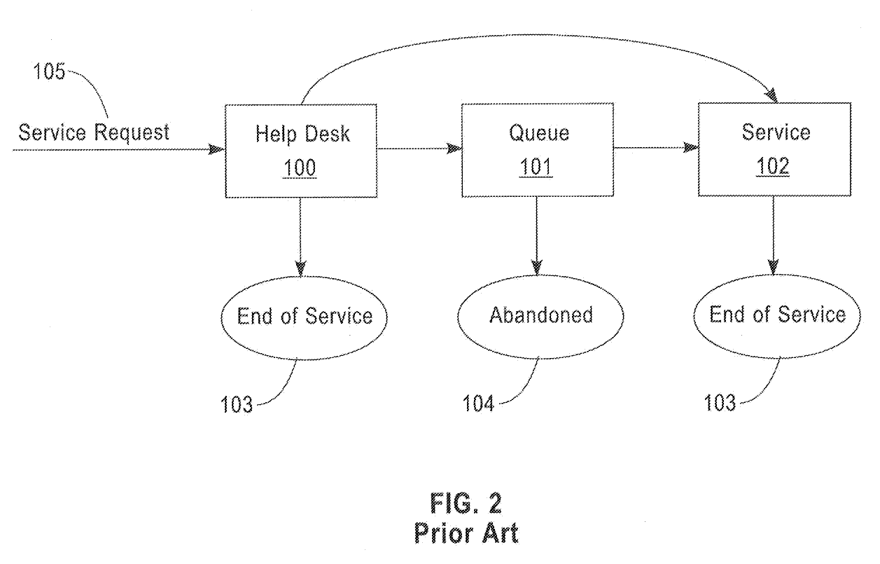

FIG. 2 illustrates the conventional flow of a typical problem ticket. The problem ticket is initiated by a service request 105 from a user or customer. The service request is provided to a help desk 100 (which may be manual or automated). Depending on the contents of the problem ticket, it might be terminated at that point. The end of service 103 could be reached in the event, for example, that the problem lies with the user's equipment and not with the service provider's equipment. Assuming that the problem ticket does not terminate at the help desk 100, the ticket is placed on a queue 101 for eventual service 102. Some of the problem tickets in the queue 101 may be abandoned at 104. When a problem ticket reaches the service function 102, it is processed and thereafter reaches an end of service 103.

The present invention attempts to both simplify the processing of the problem ticket and make that processing more powerful.

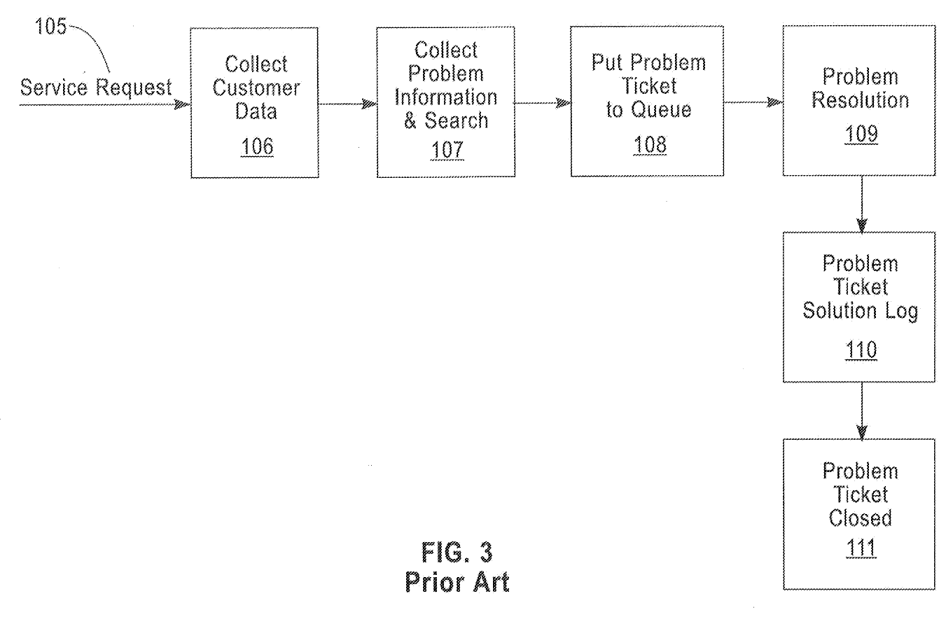

FIG. 3 shows the conventional life cycle of a problem ticket. As is the case of FIG. 2, the problem ticket is initiated by a service request 105. Function 106 collects customer data and then function 107 collects problem information and implements a search. At the conclusion of function 107, the problem ticket is ready for resolution and so it is put on the queue at function 108. At some time after the problem ticket enters the queue, it is provided to the problem resolution function 109. When resolved, information from the problem ticket is placed on the problem ticket solution log 110 and then the problem ticket is closed 111.

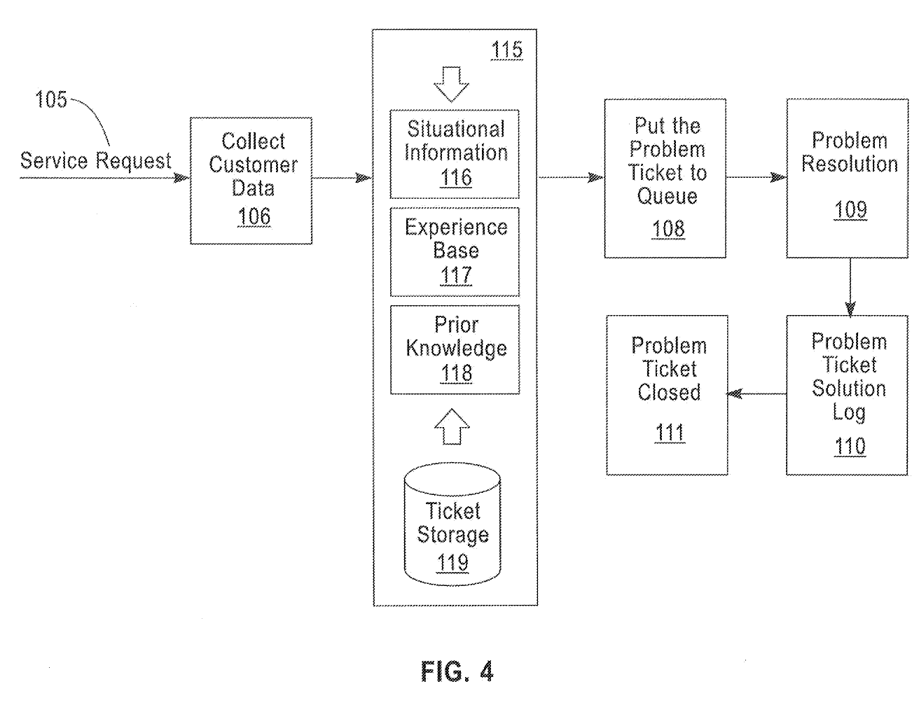

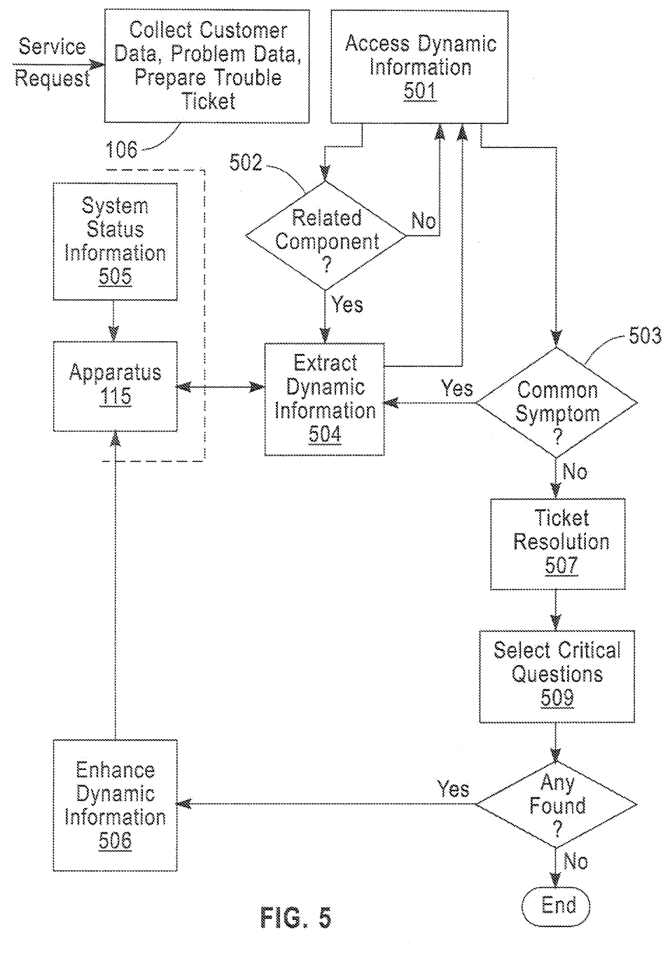

The mechanism to implement the advance provided by the invention is illustrated in FIGS. 4 and 5. FIG. 4 shows that a problem ticket is initiated by a service request 105 where the first function is to collect customer data and other problem information 106. The new function is implemented by the illustrative processor 115 and related data storage. One category of data storage is situational information 116. The situational information 116 in data storage 505 comprises information on the status of components of the user system as well as identification of components which are related to a given component. With this information one can access the data storage 505 with the identification of a component, for example a component identified in a trouble report, and identify components which are related to the identified component. Further the data storage 505 will also provide status information for the identified component as well as the related components. Data storage 505 can be implemented with suitable data storage apparatus such as electronic, magnetic or optically based data storage. Another category of data storage is an experience base 117, and a third category is prior knowledge 118. Some of this information may be derived from the ticket storage 119 which may store information derived from the solution of prior problem tickets. The experience base 117 and prior knowledge 118 may also be implemented within the data storage 505 or in a separate storage device or apparatus.

In many embodiments of the invention, the service request 105 will identify a trouble component. Starting with a trouble component we can identify a set of related components. The situational information 116 will identify the status of any related components which have failed, are not operating properly or are in an abnormal state. Those skilled in the art will realize that the status of related components is dynamic information in at least two respects. First different problem reports will usually deal with different components. In general the identity of a related component depends on the identification of a component involved in a trouble report. Accordingly, different trouble reports will usually involve different related components. Second different types of problems may suggest a different relationship between components so that even is the second problem deals with the very same component, a different problem with that component will suggest that a different relationship between the component and its related components will be important. In addition, the status of the related components, as a rule, will vary as a function of time. Thus there are at least two different dimensions to the dynamic quality of this information. One dimension is a changing complement of related components and the second dimension is the variation over time of the status of these components. In another embodiment of the invention, the situational information 116 will also relate to components which are related to the trouble component, but in this case, the identification of failed or abnormal related components is used to pose queries which will be provided to the customer or user.

In one specific embodiment, situational information 116 is dynamic information representing the status of components in the system or network. Certain components are connected so their status will affect the trouble component. If any related component is in a status other than normal, those related components in an abnormal status will be the basis for information or queries input to the problem ticket or customer. For example, if the trouble component is a Lotus Notes server, the abnormal status of network component which support the Lotus Notes server is information that will be important in the problem ticket. That information can be provided on the ticket either as a statement of fact, or as a query to elicit a response from the customer.

In still another embodiment, the dynamic information which is added to the problem ticket is derived from experience on previously resolved problem tickets. This may be implemented in several ways. For example, after problem resolution 109 on a first ticket, questions critical to the resolution of the problem are associated with the problem. Once critical questions are identified, key words in describing the problem symptoms are isolated. These key words are then correlated with a subsequent related problem or ticket, either as information or as a basis for questions.

More particularly, a set of key words are identified using this procedure for the resolution of problems associated with a particular trouble component. These key words are then correlated with new problems for the same or similar trouble components. The key words are then used either as information associated with the problem ticket, or as a basis for questions that appear in the problem ticket.

Instead of having a static set of questionnaires for the front-desk personnel to fill in, the questions for each problem ticket are dynamically changed based on the experience and feedback that are obtained from the problem resolution process. This method can be realized in the following steps.

In a first problem resolution process, mark questions critical to the resolution of the problem and associate them with the problem.

Once a problem is successfully resolved, identify the key words in describing the problem symptoms.

When a new problem arises, correlate the new problem to previous problems and select critical questions used in solving previous problems.

FIG. 5 shows one example of the process carried out by the apparatus 115 of FIG. 4. As shown in FIG. 4 that apparatus includes a database including situational information 116 and experience base 117. FIG. 5 is a functional flow diagram which also shows how information provided by a source of system status information 505 and the information in apparatus 115 is used and updated. The functional flow portion of FIG. 5 shows that a service request 105 initiates the first function to collect customer and problem data 106. For a particular trouble report the problem data can be the identification of trouble component and/or one or more trouble symptoms. That apparatus 115 has two inputs, one from a source of system status information 505 as well as a query input from the function extract dynamic information 504. System status information provides information on relationships between components as well as the status of the related components. For example for a given trouble component a, system status information will identify each related component, such as b(a), g(a) and q(a). Assuming that components b(a) and q(a) are in an abnormal status (off, not operating properly, etc.) then the apparatus 115, when queried with the identification of a particular trouble component a will return the identification of the related, abnormal components b(a) and q(a).

Once a trouble ticket is initially prepared at function 106, function 501 is executed to access dynamic information. The first step, 502 is to determine if the trouble component collected at function 106 has related data in the apparatus 115. If it does then function 504 is performed to extract the dynamic information related to the trouble component. This information is then used at function 507 for ticket resolution purposes. The dynamic information can be used in one or two ways, either the dynamic information can be added to the trouble ticket for assistance in the resolution of the trouble ticket. Continuing with the example, the dynamic information added to the trouble report for component a, will identify the related components b(a) and q(a) since they are in an abnormal state. Alternatively, the dynamic information can be used to pose additional questions to the customer reporting the trouble. In this case the customer or user can be asked if there are any observations about the operation of components b(a) or q(a).

On the other hand, assuming that function 502 does not determine that there is a common component information in the database, then processing steps to function 503 which determines if there is common symptom information in the apparatus 115. In the event there is, then function 504 is performed to extract the dynamic information from the apparatus 115. In this case, the dynamic information is information respecting resolved trouble tickets with one or more symptoms in common with the current trouble ticket. The dynamic information is then used in the resolution function 507. Once resolved critical questions in the resolved ticket are selected. Function 509 determines if any critical questions have been found. If critical questions have been found, then processing loops through function 506 to enhance the dynamic information in the database.

Information respecting the questions is collected by front-desk personnel from the reporting party.

While specific embodiments of the invention have been described it should be understood that this description is exemplary and not limiting. The scope of the invention is defined in the attached claims.

1. A method of preparing a problem ticket comprising:
receiving a problem report;
accessing a data collection based on said problem report to retrieve dynamic information related to said problem, and
forwarding said problem report including said dynamic information as a problem ticket for resolution of said problem ticket.

2. The method of claim 1 wherein said dynamic information comprises information on current status of components which are related to said problem report.

3. The method of claim 1 wherein said related components support a component identified in said problem report.

4. The method of claim 1 wherein the dynamic information is situational information.

5. The method of claim 1 wherein said problem report is received from a user and which method further includes
generating at least one question for said user in response to said dynamic information.

6. A method of preparing a problem ticket comprising:
receiving a problem report, said problem report identifying at least one problem symptom;
accessing a data collection based on said problem report to retrieve dynamic information related to said at least one problem symptoms, and
forwarding said problem report including said dynamic information as a problem ticket for resolution of said problem ticket.

7. The method of claim 6 wherein said dynamic information comprises information from closed problem tickets.

8. The method of claim 6 wherein said problem report is received from a user and which method further includes
generating at least one question for said user in response to said dynamic information.

9. A system useful in enhancing a problem ticket comprising
a data collection comprising status of target system components and relationship between target system components
means responsive to data comprising a problem report for identifying components which are either identified in said problem report or are related components
means for extracting information respecting current status of said related components, and
means for forwarding said information respecting current status for inclusion in said problem ticket.
